(19) United States
(12) Patent Application Publication
(10) Pub. No.: US 2026/0032504 A1
(43) Pub. Date: Jan. 29, 2026

(54) METHOD AND APPARATUS FOR ERROR CORRECTION IN A WIRELESS COMMUNICATION SYSTEM

(71) Applicant: SAMSUNG ELECTRONICS CO., LTD., Suwon-si, Gyeonggi-do (KR)

(72) Inventor: Mahmoud WATFA, Staines (GB)

(21) Appl. No.: 18/996,754

(22) PCT Filed: Aug. 17, 2023
(86) PCT No.: PCT/KR2023/012166

§ 371 Date: Jan. 17, 2025

(30) Foreign Application Priority Data
Aug. 18, 2022 (GB) 2212080.2
Aug. 23, 2022 (GB) 2212256.8
Jul. 18, 2023 (GB) 2310968.9

(51) Int. Cl. H04W 28/02; H04L 69/322

(52) U.S. Cl. CPC H04W 28/0268; H04L 69/322

(57) ABSTRACT

The disclosure relates to a 5G or 6G communication system for supporting a higher data transmission rate. Disclosed is a method of managing an error situation in a telecommunication network where there exists a plurality of Quality of Service, QoS, rules having a common QoS Flow Indicator, QFI, comprising the steps of: a User Equipment, UE, connected to the network, determining if a resulting QoS rule for a Guaranteed Bit Rate, GBR, QoS flow, which has no QoS flow description, is a default QoS rule and, if so, then the UE shall initiate a Protocol Data Unit, PDU, session release procedure.

### TECHNICAL FIELD

The embodiments disclosed herein relate to the field of a wireless communication system. More particularly, the embodiments disclosed herein relate to method and apparatus for error correction related to quality of service (QoS) flows in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

Currently, there are needs to enhance error correction in a wireless communication system.

### Solution to Problem

Embodiments disclosed herein provide a method of managing an error situation in a telecommunication network where there exists a plurality of quality of service, QoS, rules having a common QoS flow indicator, QFI, comprising the steps of: a user equipment, UE, connected to the network, determining if a resulting QoS rule for a guaranteed bit rate, GBR, QoS flow, which has no QoS flow description, is a default QoS rule and, if so, then the UE shall initiate a protocol data unit, PDU, session release procedure.

In an embodiment disclosed herein, wherein the PDU session release procedure is initiated by the UE sending a PDU SESSION RELEASE REQUEST message with 5GSM cause #84 “syntactical error in the QoS operation”.

In an embodiment disclosed herein, wherein if the UE determines that the QoS rule is not the default QoS rule, then the UE shall send a PDU SESSION MODIFICATION REQUEST message including a requested QoS rule Information Element, IE, to delete the QoS rule with 5GSM cause #84 “syntactical error in the QoS operation”.

Embodiments disclosed herein provide apparatus arranged to perform the method described above.

### ADVANTAGEOUS EFFECTS OF INVENTION

According to various embodiments of the disclosure, errorcorrection in a wireless communication system can be efficiently enhanced.

### BRIEF DESCRIPTION OF DRAWINGS

The embodiments are illustrated in the accompanying drawings, throughout which like reference letters indicate corresponding parts in the various figures. The embodiments herein will be better understood from the following description with reference to the drawings, in which:

FIG. 1 illustrates a QoS rule, according to the embodiments as disclosed herein;

FIG. 2 illustrates a QoS flow description, according to the embodiments as disclosed herein;

FIG. 3 illustrates a flowchart of a method according to the embodiments as disclosed herein;

FIG. 4 is a block diagram illustrating a terminal (or a user equipment (UE)), according to the embodiments as disclosed herein; and

FIG. 5 is a block diagram illustrating a base station (BS), according to the embodiments as disclosed herein.

FIG. 6 is a block diagram illustrating a structure of a network entity according to the embodiment as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### BEST MODE FOR CARRYING OUT THE INVENTION

The embodiments disclosed herein relate particularly, but not exclusively, to Fifth Generation (5G) or New Radio (NR) systems, although also has relevance to Fourth Generation (4G) systems and others.

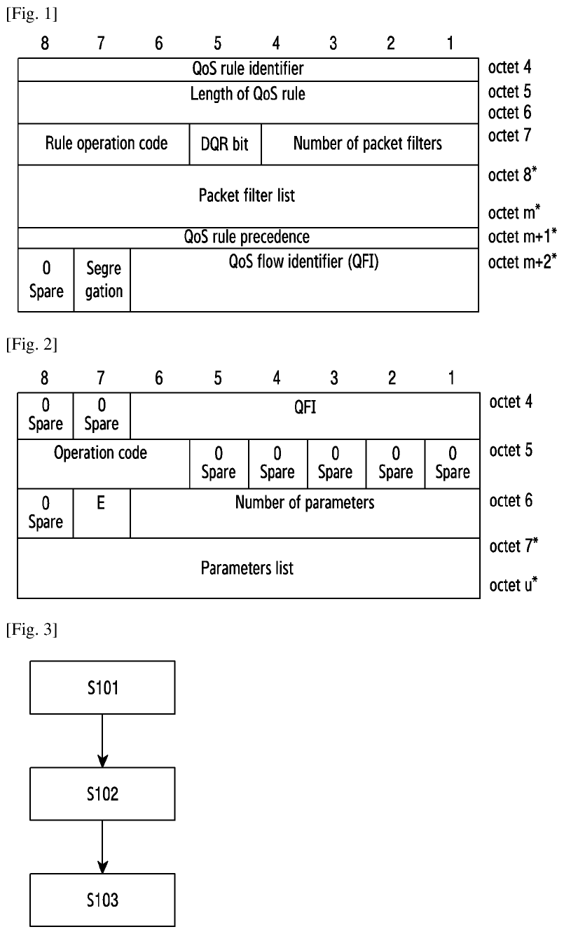

FIG. 1 shows a representation of the structure of a QoS rule, as defined in 3GPP TS 24.501 (Figure 9.11.4.13.2: QoS Rule (u=m+2)). This shows that the rule is associated with a QoS Flow Indicator (QFI) which is the link between the QoS rule and the QoS Flow description.

The QoS Flow description is illustrated in FIG. 2. The QoS rule of FIG. 1 has a field called DQR which indicates if the rule is default or not. This indicates if the rule is a default QoS rule or not.

The QoS flow description of FIG. 2 has a parameter list which contains an indication of whether the flow description is Guaranteed Bit Rate (GBR) or not.

In combination, by means of the QoS rule and QoS Flow description, it is possible to:
identify the QoS rule as default or not by means of the DQR bit;
associate the QoS rule with a QoS flow description by means of QFI i.e. they must have the same QFI to be associated; and
from within the QoS flow description content, identify if the flow is GBR or not.

A QoS flow represents the finest granularity of QoS differentiation in a protocol data unit (PDU) session. Each QoS flow is identified by a unique identifier called QoS Flow Identifier (QFI) and by QoS parameters that describe the characteristics of the packet flow. Some QoS flows are associated with a Guaranteed Bit Rate (GBR), while others are not.

In the prior art, it is possible for the situation to arise whereby there are at least two Quality of Service (QoS) flow descriptions with the same QoS Flow Indicator (QFI).

In the prior art, a possible error situation has been identified but there is no corrective action associated therewith. This was identified in the document having reference C1-224932, “Covering a missing semantic errors in QoS operations”, 3GPP TSG-CT WG1 Meeting #137-e, E-Meeting, 18th-26th August 2022.

The possible error situation can be summarised as: during the User Equipment (UE) initiated Protocol Data Unit (PDU) session establishment procedure, for semantic errors in QoS operations checked at the UE, there is no defined error of the form: “When the flow description operation is ‘Create new QoS flow description’ then two or more QoS flows associated with this PDU session would have identical QFIs”. Note that in the QoS rule case, a similar error was covered: “6) When the rule operation is ‘Create new QoS rule’ and two or more QoS rules associated with this PDU session would have identical QoS rule identifier values”.

Document C1-224932, referred to above, suggests that when there are at least two QoS flow descriptions that have the same QFI, then this is considered as an error. The same document suggests a solution to fix this problem as follows:

For a PDU session that is being established with the request type set to “initial request”, “initial emergency request” or “MA PDU request”, or a PDU session that is being transferred from EPS to 5GS and established with the request type set to “existing PDU session” or “existing emergency PDU session” or a PDU session that is being handed over between non-3GPP access and 3GPP access and established with the request type set to “existing PDU session” or “existing emergency PDU session”, the UE shall verify the authorized QoS rules and the authorized QoS flow descriptions provided in the PDU SESSION ESTABLISHMENT ACCEPT message for different types of errors as follows:

### a) Semantic Errors in QoS Operations

. . .

8a) When the flow description operation is “Create new QoS flow description” and two or more QoS flows associated with this PDU session would have identical QFIs.
. . .

In case 8, case 8a, case 9, or case 10, the UE shall send a PDU SESSION MODIFICATION REQUEST message to delete the QoS flow description with 5GSM cause #83 “semantic error in the QoS operation”.
. . .

Note that case 8a is the text (and hence solution) that is proposed in Document C1-224932. As such, the solution proposes that the UE should send the PDU SESSION MODIFICATION REQUEST message to delete the QoS flow description with 5GSM cause #83 “semantic error in the QoS operation”.

Note that there is a pre-existing QoS error defined in 3GPP TS 24.501. This is specified in 6.4.1.3 of TS 24.501, noting that the focus here is on bullet 4 (or case 4), where the other cases have been removed for brevity:

### b) Syntactical Errors in QoS Operations

. . . SKIP . . .

4) When, the rule operation is “Create new QoS rule”, there is no QoS flow description with a QFI corresponding to the QFI of the resulting QoS rule and the UE determines, by using the QoS rule's QFI as the 5QI, that there is a resulting QoS rule for a GBR QoS flow (as described in 3GPP TS 23.501 [8] table 5.7.4-1).
. . .

In case 1, case 3 or case 4, if the QoS rule is not the default QoS rule, the UE shall send a PDU SESSION MODIFICATION REQUEST message including a requested QoS rule IE to delete the QoS rule with 5GSM cause #84 “syntactical error in the QoS operation”. Otherwise, if the QoS rule is the default QoS rule, the UE shall initiate a PDU session release procedure by sending a PDU SESSION RELEASE REQUEST message with 5GSM cause #84 “syntactical error in the QoS operation”.”

As can be seen from the above for case 4, if there is no QoS flow description with a QFI corresponding to the QoS rule which has been created, and this QoS rule is a GBR (Guaranteed Bit Rate) QoS flow, then additionally:
if the QoS rule is not the default QoS rule, the UE will send the PDU SESSION MODIFICATION REQUEST message including a requested QoS rule Information Element (IE) to delete the QoS rule with 5GSM cause #84 “syntactical error in the QoS operation”, or
if the QoS rule is the default QoS rule, the UE shall initiate a PDU session release procedure by sending a PDU SESSION RELEASE REQUEST message with 5GSM cause #84 “syntactical error in the QoS operation”

From the above, it can be seen that if there is a QoS rule corresponding to a GBR QoS flow for which there is no QoS flow description, then this is considered an error. The recovery from the error is dependent on whether the QoS rule is a default QoS rule or not. If it is not the default QoS rule, then the UE initiates the PDU session modification procedure to delete the QoS rule which does not have a QoS flow description. On the other hand, if the QoS rule is a default QoS rule which does not have a corresponding QoS flow description, then the UE releases the PDU session.

So, in summary, it can be seen that a QoS rule for a GBR QoS flow cannot exist without a QoS flow description.

The solution proposed in Document C1-224932 referred to above can lead to cases in which there is no QoS flow description that is associated with a QoS rule that corresponds to a GBR QoS flow.

To further understand the problem, the following example is instructive.

Assume a QoS rule for which the QFI is QFI #5, where the number 5 is just being used as an example. Now assume there are at least two QoS flow descriptions which are associated with QFI #5.

According to the solution in Document C1-224932, the UE will send the PDU Session Modification Request message to delete the QoS flow description with QFI #5. So let us assume that the QoS flow description with QFI #5 is now deleted as suggested in Document C1-224932. After this happens, we are now left with a QoS rule which does not have a QoS flow description.

According to the current specification in 3GPP TS 24.501 V17.7.1, as quoted previously, if a QoS rule exists which is for a GBR QoS flow and this QoS rule does not have a corresponding QoS flow description, then the UE will either have to delete the QoS rule (if the QoS rule is not a default QoS rule) or the UE will have to release the PDU session altogether (if the QoS rule is indeed the default QoS rule).

Therefore, the solution in Document C1-224932 can lead to a situation whereby the QoS flow description is deleted, such that the remaining QoS rule will not have any QoS flow. And if this QoS rule is for a GBR QoS flow, then such an outcome is indeed problematic as specified in 3GPP TS 24.501 V17.7.1, referred to above. Hence the solution proposed in Document C1-224932 is not complete and can actually cause a new problem, i.e. where a QoS rule for a GBR QoS flow would not be associated with a QoS flow description, while it attempts to solve another problem, i.e. the problem of having at least two QoS flow descriptions with the same QFI.

It is an aim of embodiments of the invention to address shortcomings in the prior art, whether mentioned herein or not.

According to the present invention there is provided an apparatus and method as set forth in the appended claims. Other features of the invention will be apparent from the dependent claims, and the description which follows.

According to a first aspect of the present invention there is provided method of managing an error situation in a telecommunication network where there exists a plurality of Quality of Service, QoS, rules having a common QoS Flow Indicator, QFI, comprising the steps of: a User Equipment, UE, connected to the network, determining if a resulting QoS rule for a Guaranteed Bit Rate, GBR, QoS flow, which has no QoS flow description, is a default QoS rule and, if so, then the UE shall initiate a Protocol Data Unit, PDU, session release procedure.

In an embodiment, the PDU session release procedure is initiated by the UE sending a PDU SESSION RELEASE REQUEST message with 5GSM cause #84 “syntactical error in the QoS operation”.

In an embodiment, if the UE determines that the QoS rule is not the default QoS rule, then the UE shall send a PDU SESSION MODIFICATION REQUEST message including a requested QoS rule Information Element, IE, to delete the QoS rule with 5GSM cause #84 “syntactical error in the QoS operation”.

According to a second aspect of the present invention there is provided apparatus arranged to perform the method of the first aspect.

Embodiments of the invention address the case when there are at least two QoS flow descriptions with the same QFI. Unlike the solution proposed in Document C1-224932, which proposes only one UE action and which can actually result in another problem, embodiments of the invention provide at least one solution to address and resolve the identified problem in a manner that is correct, consistent and avoids other potential problems. Embodiments provide that the UE may take different actions based on different conditions.

For example, while the solution in Document C1-224932 suggests that the QoS flow descriptions themselves need to be deleted by the UE (e.g. by means of signalling with the network), embodiments of the invention provide that the UE, after determining that at least two QoS flow descriptions have the same QFI, should further verify if the associated QoS rule is for a GBR QoS flow or not. If it is for a non-GBR QoS flow, then the UE can go ahead and delete the identified QoS flow descriptions by sending the appropriate Non Access Stratum (NAS) session management message to the network and include the necessary cause code/value e.g. an existing cause value.

On the other hand, if the QoS rule which is associated with the identified (at least two) QoS flow descriptions is for a GBR QoS flow, then the UE should verify if the QoS rule is the default QoS rule or not. If the QoS rule is the default QoS rule, then the UE sends the necessary NAS session management message to release the entire PDU session (or PDN connection) and include the necessary cause code/value e.g. an existing cause value. Otherwise if the QoS rule is not the default QoS rule, then performs the PDU session modification procedure to delete the QoS rule which is associated with the identified QoS flow description and include the necessary cause code/value e.g. an existing cause value.

Therefore, embodiments of the invention deal with the situation whereby the existence of at least two QoS flow descriptions with the same QFI can lead to different actions by the UE (as set out herein), where these actions may be any of:
Sending a NAS message to delete the QoS flow descriptions that have the same QFI
Sending a NAS message to delete the QoS rule which is associated with the identified QoS flow descriptions that have the same QFI
Sending a NAS message to delete the entire PDU session which has the identified QoS flow descriptions that have the same QFI
Local deletion of the QoS flow descriptions that have the same QFI

As can be seen, unlike the solution in Document C1-224932, the UE may take different actions based on certain different conditions.

Although a few preferred embodiments of the present invention have been shown and described, it will be appreciated by those skilled in the art that various changes and modifications might be made without departing from the scope of the invention, as defined in the appended claims.

According to a first embodiment of the invention, further verifications and actions may be performed by the UE when there are at least two QoS flow descriptions with the same QFI.

This embodiment may apply to a UE which is in N1 mode and hence receives the QoS rules operations and QoS flow descriptions operations directly in a 5GSM message. The proposals can also apply if the UE is in S1 mode and has received these operations as part of the ESM messages which are sent in S1 mode (and optionally as part of any information element, IE, where these parameters may be included). As such, the embodiment applies regardless of the UE being in N1 mode or S1 mode.

Furthermore, the details of any steps required apply in any combination or order. For example, if the UE checks for a certain condition, say Condition A, and then checks for another condition, say Condition B, where Condition B is verified after Condition A, then it is equally valid for the UE to first verify Condition B and then verify Condition A. Similarly, any action taken due to verifying any condition may be taken in any order that may precede or follow another action that in turn could be taken in association with another condition.

When (or if) the UE detects that there are at least two QoS flow descriptions with the same QFI, the UE needs to verify if the QoS rule that is associated with the identified QoS flow descriptions (e.g. the at least two QoS flow descriptions which have the same QFI) is a QoS rule for a GBR QoS flow or is for a non-GBR QoS flow.

If the UE determines that the QoS rule in question is for a non-GBR QoS flow or is not for a GBR QoS flow, then:
a) the UE sends the PDU SESSION MODIFICATION REQUEST message to delete the QoS flow description with 5GSM cause #83 “semantic error in the QoS operation”. Note that the UE may also delete the QoS rule(s) that is (are) associated with the QoS flow descriptions. Alternatively the UE may locally delete the QoS rule(s) that is (are) associated with the QoS flow descriptions. As such, the same NAS message (i.e. the PDU SESSION MODIFICATION REQUEST message) is used by the UE to delete both the QoS rule(s) and the QoS flow descriptions that are associated with the QoS rule(s) (e.g. where this association is based on having the same QFI).
b) alternatively, the UE locally deletes all the QoS flow descriptions which have been identified to have a common (or the same) QFI. In this case, the UE may not consider this to be an error, or may consider this to be an error which has been (or should be) rectified locally in the UE (by means of a local deletion) without sending a 5GSM message to the network (e.g. to the session management function (SMF)). Optionally the UE may delete all QoS flow descriptions except one, i.e. the UE keeps only one QoS flow description. Optionally which one to keep may be based on implementation in the UE or, for example, based on policies in the UE or, for example, the UE may delete any QoS flow description which implies that the QoS flow is a GBR flow which would contradict the UE's determination that the QoS rule is for a non-GBR QoS flow.
c) For any of the steps a) or b) above, the UE may optionally only apply them if the UE is not in NB-N1 mode (i.e. optionally the UE applies the proposals if the UE is not using narrow band, noting that this may also apply for a UE in S1 mode and hence the steps can apply optionally if the UE is not in NB-S1 mode i.e. the UE is not using narrow band in S1 mode). For example, the UE optionally only applies the proposals when in Wide Band i.e. when in WB-N1 mode or WB-S1 mode.
d) Optionally, the UE may release the PDU session by sending the PDU Session Release Request message. Note that this specific proposal may apply even if the QoS rule is for a GBR QoS flow. As such, if the UE determines that there is more than one QoS flow description with the same QFI, then the UE may initiate the release of the PDU session and include the appropriate 5GSM cause which may be an existing cause value e.g. “semantic error in the QoS operation” or #84 “syntactical error in the QoS operation”, etc.

The steps above may apply in any order or combination.

If the UE determines that the QoS rule in question is for a GBR QoS flow, then the UE should further verify if the QoS rule in question is a default QoS rule or is not a default QoS rule. Consequently:
a) if the UE determines that the QoS rule in question is a default QoS rule, then since this would be problematic as has been described earlier (i.e. there would result a default QoS rule which would not have any QoS flow description if the UE deletes the QoS flow descriptions that have the same QFI), then the UE shall initiate a PDU session release procedure by sending a PDU SESSION RELEASE REQUEST message with 5GSM cause #84 “syntactical error in the QoS operation”
b) if the UE determines that the QoS rule in question is not the default QoS rule, then the UE shall send a PDU SESSION MODIFICATION REQUEST message including a requested QoS rule IE to delete the QoS rule with 5GSM cause #84 “syntactical error in the QoS operation”. The UE may also request the deletion of the QoS flow descriptions
c) Alternatively, the UE may verify (either before or after the verifications proposed above) if the identified QoS flow descriptions, which have the same QFI, have other similar contents i.e. if the other fields within the QoS flow descriptions have the same contents or values:
i. If yes, then the UE may behave as described above
ii. If no, then the UE may locally delete some of the QoS flow descriptions such that only one remains. How to choose which one is kept may be based on implementation. Or alternatively, the UE may maintain the QoS flow description which is for a GBR QoS flow, or the UE may maintain the QoS flow description which is not for a GBR QoS flow
iii. Alternatively the UE may always locally delete some of the QoS flow descriptions such that only one remains. How to choose which one is kept may be based on implementation. Or alternatively, the UE may maintain the QoS flow description which is for a GBR QoS flow, or the UE may maintain the QoS flow description which is not for a GBR QoS flow

The steps above may apply in any order or combination

Note that the details above may be applicable to either QoS rule for GBR QoS flow or QoS rule that is not for GBR QoS flow.

Alternatively, or optionally, regardless of the QoS rule being for a GBR rule or not, if the UE determines that the QoS rule in question is a default QoS rule, (i.e. there would result a default QoS rule which would not have any QoS flow description if the UE deletes the QoS flow descriptions that have the same QFI), then the UE shall initiate a PDU session release procedure by sending a PDU SESSION RELEASE REQUEST message with 5GSM cause #84 “syntactical error in the QoS operation”.

Alternatively, or optionally, regardless of the QoS rule being for a GBR rule or not, if the UE determines that the QoS rule in question is not default QoS rule, (i.e. there would result a non-default QoS rule which would not have any QoS flow description if the UE deletes the QoS flow descriptions that have the same QFI), then the UE shall send a PDU SESSION MODIFICATION REQUEST message to delete the QoS flow description with 5GSM cause #83 “semantic error in the QoS operation”.

Note that this behaviour may optionally apply for a UE which is not in NB-N1 mode (or optionally for a UE which is not in NB-S1 mode). The UE may also send the same NAS message to delete the associated QoS rule(s). Or, the UE may use the same message to delete both the QoS rule(s) and the QoS flow descriptions.

Optionally, the UE behaviour may be as any combination of the following (when the conditions described earlier or herein have been detected):
(a) if the associated QoS rule is the default QoS rule, then the UE shall initiate a PDU session release procedure by sending a PDU SESSION RELEASE REQUEST message with 5GSM cause #83 “semantic error in the QoS operation”;
   Optionally, if this happens during the PDU session modification procedure, the UE may perform the PDU session release before or after the completion of the PDU session modification procedure
(b) if the associated QoS rule is the default QoS rule, and optionally if the default QoS rule is for a GBR QoS flow, then the UE shall initiate a PDU session release procedure by sending a PDU SESSION RELEASE REQUEST message with 5GSM cause #83 “semantic error in the QoS operation”;
   Optionally, if this happens during the PDU session modification procedure, the UE may perform the PDU session release before or after the completion of the PDU session modification procedure
(c) if the associated QoS rule is the default QoS rule, and optionally if the default QoS rule is not for a GBR QoS flow, then the UE shall send a PDU SESSION MODIFICATION REQUEST message to delete the QoS flow descriptions with 5GSM cause #83 “semantic error in the QoS operation”; or
   Optionally, if this happens during the PDU session modification procedure, the UE may perform the proposals above but instead SESSION MODIFICATION REJECT message, or alternatively the UE may detect that an error has occurred and reject the modification procedure and send the SESSION MODIFICATION REJECT message
(d) if the associated QoS rule is not the default QoS rule, then the UE shall send a PDU SESSION MODIFICATION REQUEST message to delete the QoS rule(s) and optionally also delete the QoS flow descriptions. The NAS message may include the 5GSM cause #83 “semantic error in the QoS operation” or any other cause value
   Optionally, if this happens during the PDU session modification procedure, the UE may perform the proposals above but instead SESSION MODIFICATION REJECT message, or alternatively the UE may detect that an error has occurred and reject the modification procedure and send the SESSION MODIFICATION REJECT message
(e) if the associated QoS rule is not the default QoS rule, and optionally if the QoS rule is for a GBR QoS flow, then the UE shall send a PDU SESSION MODIFICATION REQUEST message to delete the QoS rule(s) and/or also optionally delete the QoS flow descriptions. The NAS message may include the 5GSM cause #83 “semantic error in the QoS operation” or any other cause value
   Optionally, if this happens during the PDU session modification procedure, the UE may perform the proposals above but instead SESSION MODIFICATION REJECT message, or alternatively the UE may detect that an error has occurred and reject the modification procedure and send the SESSION MODIFICATION REJECT message
(f) if the QoS rule is not for a GBR QoS flow, then the UE send a PDU SESSION MODIFICATION REQUEST message to delete the QoS flow descriptions and include 5GSM cause #83 “semantic error in the QoS operation” or any other cause value. This may be applicable to a QoS rule which is not the default QoS rule or to a QoS rule which is a default QoS rule. As such the UE may verify any such condition.
   Optionally, if this happens during the PDU session modification procedure, the UE may perform the proposals above but instead SESSION MODIFICATION REJECT message, or alternatively the UE may detect that an error has occurred and reject the modification procedure and send the SESSION MODIFICATION REJECT message
(g) the UE may locally delete any QoS rule or optionally any QoS flow description (or both). This may be applied regardless of whether the QoS rule is for a GBR flow or not i.e. as such it can be applied for either when the QoS rule is for a GBR flow, or when the QoS rule is not for a GBR flow
(h) Optionally the UE may take any of the actions above if the UE is not in NB-N1 mode (or not in NB-S1 mode). For example, the UE optionally only applies the proposals when in Wide Band i.e. WB-N1 mode or WB-S1 mode.

Note that any of the steps set out can apply when the UE detects the conditions listed herein (e.g. there is more than one QoS flow description with the same QFI and optionally the resulting QoS rule is a default QoS rule, or for a GBR QoS flow, etc, as has been listed herein) even if the starting point is different. For example, the UE may apply the same actions proposed herein if it detects there is a QoS rule which is for a GBR QoS flow and there is not associated QoS flow description, but the QoS operation is different from “Create new QoS flow description”. As such, any QoS operation on QoS rules or QoS flow descriptions or both which lead to the same outcome may therefore lead to the same actions by the UE as set out herein.

For example, when the rule operation is “Create new QoS rule”, and there is no QoS flow description with a QFI corresponding to the QFI of the resulting QoS rule, then the UE may take any combination of the steps set out above. For example:
if the QoS rule is the default QoS rule, then the UE may release the PDU session (and send the PDU Session Release Request message) even if the QoS rule in question is not for a GBR flow. The NAS message may include the 5GSM cause #83 “semantic error in the QoS operation” or any other cause value
Optionally, if this happens during the PDU session modification procedure, the UE may perform the proposals above but instead SESSION MODIFICATION REJECT message, or alternatively the UE may detect that an error has occurred and reject the modification procedure and send the SESSION MODIFICATION REJECT message
If the QoS rule is not the default QoS rule, the UE may perform the PDU session modification procedure (and send the PDU Session Modification Request message) to delete the QoS rule, or the QoS flow descriptions, or both the QoS rule(s) and the QoS flow descriptions. The NAS message may include the 5GSM cause #83 “semantic error in the QoS operation” or any other cause value
Optionally, if this happens during the PDU session modification procedure, the UE may perform the proposals above but instead SESSION MODIFICATION REJECT message, or alternatively the UE may detect that an error has occurred and reject the modification procedure and send the SESSION MODIFICATION REJECT message

Note that for all the steps set out herein, other existing 5GSM cause values or other existing ESM cause values may be used in the NAS message that the UE sends to the network. Alternatively new values may also be defined and used.

All steps may be applicable in any order or combination.

Note that the steps and methods herein apply regardless of the message that the UE receives. For example, the UE verifies for errors or conditions listed herein when the UE receives the PDU Session Establishment Accept message, or the PDU Session Modification Command message.

Optionally, if the errors are detected during the PDU session modification procedure, the UE may send the PDU Session Modification Reject message instead and perform the necessary operations (e.g. to delete a QoS rule or QoS flow description or both) and include the 5GSM cause value as listed. Therefore, for the steps above where the UE is supposed to send a PDU Session Modification Request message, the UE may instead send the PDU Session Modification Reject message. Furthermore, the UE may send any PDU Session Release Request message (as set out herein) after any ongoing PDU session modification procedure is completed.

Therefore all the steps above are not restricted to a particular procedure or message and, as such, can be used in the same manner where the UE may send different messages (e.g. PDU Session Modification Request message or PDU Session Modification Reject message) to perform the proposed QoS operations when any of the conditions or errors set out herein are detected.

The UE may take any of the actions or steps that have been set out above in any order or combination. Note that if the proposals above are executed in S1 mode, the UE may send any existing ESM cause value in the ESM message. However, in general, the same proposals can also be applicable.

It should be noted that a QoS rule may be determined to be associated with a QoS flow description by means of the QFI in each of these parameters.

It should be noted that the UE may use the QoS rule's QFI as the 5G QoS Identifier (5Q1) when determining if the QoS rule is for a GBR QoS flow or not (as described in 3GPP TS 23.501). 5QI is s a pointer to a set of QoS characteristics such as priority level, packet delay or packet error rate.

By way of completeness, FIG. 3 shows a flowchart illustrating an embodiment of the invention. At step S101, there exists a plurality of Quality of Service, QoS, rules having a common QoS Flow Indicator, QFI. At step S102, a User Equipment, UE, connected to the network, determines if a resulting QoS rule for a Guaranteed Bit Rate, GBR, QoS flow, which has no QoS flow description is a default QoS rule and if so, at S103, UE initiates a Protocol Data Unit, PDU, session release procedure.

FIG. 4 is a block diagram illustrating a terminal (or a user equipment (UE)), according to the embodiments as disclosed herein.

As shown in FIG. 4, a terminal according to an embodiment may include a transceiver 410, a memory 420, and a processor (or a controller) 430. The transceiver 410, the memory 420, and the processor (or controller) 430 of the terminal may operate according to a communication method of the terminal described above. However, the components of the terminal are not limited thereto. For example, the terminal may include more or fewer components than those described in FIG. 4. In addition, the processor (or controller) 430, the transceiver 410, and the memory 420 may be implemented as a single chip. Also, the processor (or controller) 430 may include at least one processor.

The transceiver 410 collectively refers to a terminal station receiver and a terminal transmitter, and may transmit/receive a signal to/from a base station or another terminal. The signal transmitted or received to or from the terminal may include control information and data. The transceiver 410 may include a RF transmitter for up-converting and amplifying a frequency of a transmitted signal, and a RF receiver for amplifying low-noise and down-converting a frequency of a received signal. However, this is only an example of the transceiver 410 and components of the transceiver 410 are not limited to the RF transmitter and the RF receiver.

Also, the transceiver 410 may receive and output, to the processor (or controller) 430, a signal through a wireless channel, and transmit a signal output from the processor (or controller) 430 through the wireless channel.

The memory 420 may store a program and data required for operations of the terminal. Also, the memory 420 may store control information or data included in a signal obtained by the terminal. The memory 420 may be a storage medium, such as read-only memory (ROM), random access memory (RAM), a hard disk, a CD-ROM, and a DVD, or a combination of storage media.

The processor (or controller) 430 may control a series of processes such that the terminal operates as described above. For example, the processor (or controller) 430 may receive a data signal and/or a control signal, and the processor (or controller) 430 may determine a result of receiving the signal transmitted by the base station and/or the other terminal.

FIG. 5 is a block diagram illustrating a base station (BS), according to the embodiments as disclosed herein.

As shown in FIG. 5 is, the base station of the present disclosure may include a transceiver 510, a memory 520, and a processor (or, a controller) 530. The transceiver 510, the memory 520, and the processor (or controller) 530 of the base station may operate according to a communication method of the base station described above. However, the components of the base station are not limited thereto. For example, the base station may include more or fewer components than those described in FIG. 5. In addition, the processor (or controller) 530, the transceiver 510, and the memory 520 may be implemented as a single chip. Also, the processor (or controller) 530 may include at least one processor.

The transceiver 510 collectively refers to a base station receiver and a base station transmitter, and may transmit/receive a signal to/from a terminal, another base station, and/or a core network function(s) (or entity(s)). The signal transmitted or received to or from the base station may include control information and data. The transceiver 510 may include a RF transmitter for up-converting and amplifying a frequency of a transmitted signal, and a RF receiver for amplifying low-noise and down-converting a frequency of a received signal. However, this is only an example of the transceiver 510 and components of the transceiver 510 are not limited to the RF transmitter and the RF receiver.

Also, the transceiver 510 may receive and output, to the processor (or controller) 530, a signal through a wireless channel, and transmit a signal output from the processor (or controller) 530 through the wireless channel.

The memory 520 may store a program and data required for operations of the base station. Also, the memory 520 may store control information or data included in a signal obtained by the base station. The memory 520 may be a storage medium, such as ROM, RAM, a hard disk, a CD-ROM, and a DVD, or a combination of storage media.

The processor (or controller) 530 may control a series of processes such that the base station operates as described above. For example, the processor (or controller) 530 may receive a data signal and/or a control signal, and the processor (or controller) 530 may determine a result of receiving the signal transmitted by the terminal and/or the core network function.

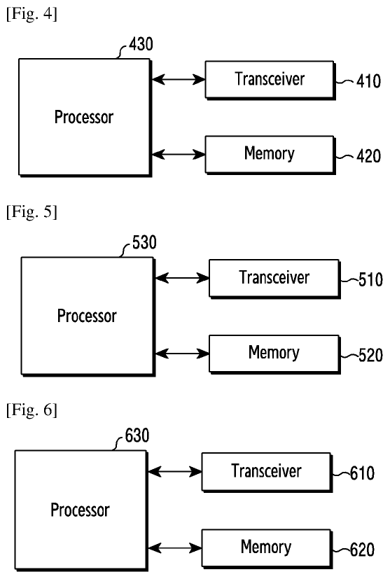

FIG. 6 is a block diagram illustrating a structure of a network entity according to the embodiment as disclosed herein.

As shown in FIG. 6, the network entity of the present disclosure may include a transceiver 610, a memory 620, and a processor 630. The transceiver 610, the memory 620, and the processor 630 of the network entity may operate according to a communication method of the network entity described above. However, the components of the terminal are not limited thereto. For example, the network entity may include more or fewer components than those described above. In addition, the processor 630, the transceiver 610, and the memory 620 may be implemented as a single chip. Also, the processor 630 may include at least one processor.

The transceiver 610 collectively refers to a network entity receiver and a network entity transmitter, and may transmit/receive a signal to/from a base station or a UE. The signal transmitted or received to or from the base station or the UE may include control information and data. In this regard, the transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the network entity. Also, the memory 620 may store control information or data included in a signal obtained by the network entity. The memory 620 may be a storage medium, such as ROM, RAM, a hard disk, a CD-ROM, and a DVD, or a combination of storage media.

The processor 630 may control a series of processes such that the network entity operates as described above. For example, the transceiver 610 may receive a data signal including a control signal, and the processor 630 may determine a result of receiving the data signal.

The methods according to the embodiments described in the claims or the detailed description of the present disclosure may be implemented in hardware, software, or a combination of hardware and software.

When the electrical structures and methods are implemented in software, a computer-readable recording medium having one or more programs (software modules) recorded thereon may be provided. The one or more programs recorded on the computer-readable recording medium are configured to be executable by one or more processors in an electronic device. The one or more programs include instructions to execute the methods according to the embodiments described in the claims or the detailed description of the present disclosure.

The programs (e.g., software modules or software) may be stored in random access memory (RAM), non-volatile memory including flash memory, read-only memory (ROM), electrically erasable programmable read-only memory (EEPROM), a magnetic disc storage device, compact disc-ROM (CD-ROM), a digital versatile disc (DVD), another type of optical storage device, or a magnetic cassette. Alternatively, the programs may be stored in a memory system including a combination of some or all of the above-mentioned memory devices. In addition, each memory device may be included by a plural number.

The programs may also be stored in an attachable storage device which is accessible through a communication network such as the Internet, an intranet, a local arca network (LAN), a wireless LAN (WLAN), or a storage area network (SAN), or a combination thereof. The storage device may be connected through an external port to an apparatus according the embodiments of the present disclosure. Another storage device on the communication network may also be connected to the apparatus performing the embodiments of the present disclosure.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an clement expressed in a plural form may also be configured as a single element, and an clement expressed in a singular form may also be configured as plural elements.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a user equipment (UE) for error correction in a wireless communication system, the method comprising:
determining whether a plurality of quality of service (QoS) rules have a common QoS flow indicator (QFI),
in case that the plurality of QoS rules have the common QFI, determining whether a first QoS rule is for a guaranteed bit rate (GBR) QoS flow, which has no QoS flow description,
in case that the first QoS rule is for the GBR QoS flow, determining whether the first QoS rule is a default QoS rule, and
in case that the first QoS rule is the default QoS rule, initiating a protocol data unit (PDU) session release procedure.

2. The method of claim 1, wherein the method further comprises transmitting, to a network entity (NE), a PDU SESSION RELEASE REQUEST message with 5GSM cause #84 “syntactical error in the QoS operation” to initiate the PDU session release procedure.

3. The method of claim 1, wherein the method further comprises in case that the first QoS rule is not the default QoS rule, transmitting, to a network entity (NE), a PDU SESSION MODIFICATION REQUEST message including a requested QoS rule information element (IE) to delete the first QoS rule with 5GSM cause #84 “syntactical error in the QoS operation”.

4. The method of claim 1, wherein the method further comprises, in case that the first QoS rule is for a non-GBR QoS flow, transmitting, to a network entity (NE), a Non Access Stratum (NAS) session management message to delete identified QoS flow descriptions.

5. A user equipment (UE) in a wireless communication system, the UE comprising:
a transceiver;
a controller coupled with the transceiver and configured to:
determine whether a plurality of quality of service (QoS) rules have a common QoS flow indicator (QFI),
in case that the plurality of QoS rules have the common QFI, determine whether a first QoS rule for a guaranteed bit rate (GBR) QoS flow, which has no QoS flow description,
in case that the first QoS rule is for the GBR QoS flow, determine whether the first QoS rule is a default QoS rule; and,
in case that the first QoS rule is the default QoS rule, initiate a protocol data unit (PDU) session release procedure.

6. The UE of claim 5, wherein the controller is further configured to transmit, to a network entity, a PDU SESSION RELEASE REQUEST message with 5GSM cause #84 “syntactical error in the QoS operation” to initiate the PDU session release procedure.

7. The UE of claim 5, wherein, in case that the first QoS rule is not the default QoS rule, the controller is further configured to transmit, to a network entity, a PDU SESSION MODIFICATION REQUEST message including a requested QoS rule information element (IE) to delete the first QoS rule with 5GSM cause #84 “syntactical error in the QoS operation”.

8. The UE of claim 5, wherein, in case that the first QoS rule is for a non-GBR QoS flow, the controller is further configured to transmit, to a network entity (NE), a Non Access Stratum (NAS) session management message to delete identified QoS flow descriptions.

9. A method performed by a network entity (NE) for error correction in a wireless communication system, the method comprising:
in response that a plurality of quality of service (QoS) rules have a common QoS flow indicator (QFI), that a first QoS rule is for a guaranteed bit rate (GBR) QoS flow, which has no QoS flow description, that the first QoS rule is for the GBR QoS flow, and that the first QoS rule is the default QoS rule, receiving, from a user equipment (UE), a PDU SESSION RELEASE REQUEST message with 5GSM cause #84 “syntactical error in the QoS operation” to initiate a PDU session release procedure.

10. The method of claim 9, the method further comprises, in case that the first QoS rule is not the default QoS rule, receiving, from the UE, a PDU SESSION MODIFICATION REQUEST message including a requested QoS rule information element (IE) to delete the first QoS rule with 5GSM cause #84 “syntactical error in the QoS operation”

11. The method of claim 9, wherein the method further comprises, in case that the first QoS rule is for a non-GBR QoS flow, receiving, from the UE, a Non Access Stratum (NAS) SESSION MANAGEMENT message to delete identified QoS flow descriptions.

12. A network entity (NE) in a wireless communication system, the NE comprising:
a transceiver;
a controller coupled with the transceiver and configured to:
in response that a plurality of quality of service (QoS) rules have a common QoS flow indicator (QFI), that a first QoS rule is for a guaranteed bit rate (GBR) QoS flow, which has no QoS flow description, that the first QoS rule is for the GBR QoS flow, and that the first QoS rule is the default QoS rule, receive, from a user equipment (UE), a PDU SESSION RELEASE REQUEST message with 5GSM cause #84 “syntactical error in the QoS operation”.

13. The NE of claim 12, wherein the PDU SESSION RELEASE REQUEST message is for initiation a PDU session release procedure.

14. The NE of claim 12, wherein the controller is further configured to receive, from the UE, a PDU SESSION MODIFICATION REQUEST message including a requested QoS rule information element (IE) for deletion of the first QoS rule with 5GSM cause #84 “syntactical error in the QoS operation”, in case that the first QoS rule is not the default QoS rule.

15. The NE of claim 12, wherein the controller is further configured to receive, from the UE, a Non Access Stratum (NAS) session management message for deletion identified QoS flow descriptions, in case that the first QoS rule is for a non-GBR QoS flow.
